(19) United States
(12) Patent Application Publication
(10) Pub. No.: US 2026/0070066 A1
(43) Pub. Date: Mar. 12, 2026

(54) CASCADING DENSITY SEPARATORS FOR FACILITATING DENSITY-BASED CLASSIFICATION OF PARTICULATE MATERIAL

(71) Applicant: Nick Shilatz, JR., Mt pleasant, PA (US)

(72) Inventor: Nick Shilatz, JR., Mt pleasant, PA (US)

(21) Appl. No.: 19/323,883

(22) Filed: Sep. 9, 2025

Related U.S. Application Data
(60) Provisional application No. 63/692,534, filed on Sep. 9, 2024.

(51) Int. Cl. B03B 5/36; B03B 5/44; G01N 9/34

(52) U.S. Cl. CPC B03B 5/36; B03B 5/44; G01N 9/34

(57) ABSTRACT

The present disclosure provides a cascading density separator for facilitating density-based classification of particulate material. Further, the cascading density separator may include a basin defining an interior channel and comprising a first lateral wall and a second lateral wall, the second lateral wall including an outwardly angled deflection portion at a 45° angle relative of a spiral classifier disposed in the interior channel, the basin. Further, the cascading density separator may include a spiral classifier positioned within the basin and interposed between the first lateral wall and the second lateral wall, the spiral classifier. Further, the cascading density separator may include a spray nozzle mounted, the spray nozzle configured for spraying water into the interior channel and washing a lighter material from the particulate material downward for discharge while enabling the denser material to be retained and lifted by the spiral classifier.

### FIELD OF DISCLOSURE

The present disclosure relates to the field of gravimetric separating devices. More specifically, the present disclosure relates to cascading density separators for facilitating density-based classification of particulate material.

### BACKGROUND

The field of gravity-driven classification of particulate material in liquid carrier is important because accurate and stable separation of particles according to density and, where relevant, size directly affects recovery yield, product grade, water and energy consumption, equipment footprint, and operational uptime across a wide range of slurry-handling industries.

An overarching objective in the given field is to achieve selective and repeatable density-based classification of particulate material from a slurry stream while maintaining a compact installation, low specific energy and water demand, and robust operation over variable feed conditions and prolonged service intervals.

However, existing devices and process arrangements for density-based classification may encounter difficulties that impede attainment of the given objective. Certain equipment geometries may allow partially separated particles to bypass subsequent discrimination zones, limiting the number of effective classification opportunities available within a given footprint. Flow patterns within some channels may produce uneven hydraulic shear and non-uniform wash distribution, which may entrain lighter particles with heavier fractions or allow heavier particles to drift into lighter discharge streams. Reintroduction of displaced solids into the main flow path may be unstable in some layouts, giving rise to dead zones, stagnant pockets, and localized pooling that impair separation consistency and promote fouling. In various installations, discontinuities at internal junctions or abrupt changes in wall shape may accumulate solids, contributing to caking, increased downtime, and variable product quality.

Other challenges may arise from limited adaptability to feed variability. Fixed mechanical or hydraulic settings may not provide adequate control over dwell time, return path residence, or recirculation intensity as slurry composition, flow rate, and particle size distribution change during operation. Rotating elements in some systems may suffer from misalignment or runout that narrows clearance intermittently, disturbing flow symmetry and generating wear. Basin floors or channel bottoms that do not guide returning solids consistently may create recirculation loops that delay discharge of lighter fractions or prematurely lift heavier fractions. Handoff regions between conveying structures and return paths may fail to capture the moving solids stream reliably under upset or transient conditions, causing erratic performance.

Process monitoring and maintainability present additional pain points. Without timely indication of gradual wear or geometry drift in wetted surfaces, classification cut-points may shift unnoticed. Mechanical reconfiguration to accommodate different ore bodies or operating targets may consume considerable time when angle, clearance, or water-delivery orientation must be changed using tools or replacement parts. Surface interactions between slurry and internal walls may be affected by fouling, adhesion, and wettability changes that reduce hydraulic efficiency and disrupt stable films, especially with fine or clay-rich feeds. Wash-water delivery that lacks directional control or dynamic modulation may be ineffective at dislodging boundary layers of fines during periods of elevated solids loading. Finally, control schemes that do not incorporate real-time feedback from the return stream or discharge clarity may respond slowly to disturbances, allowing transient off-spec operation.

Therefore, there is a need for cascading density separators for facilitating density-based classification of particulate material that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a cascading density separator for facilitating density-based classification of particulate material. Further, the cascading density separator may include a basin defining an interior channel. Further, the basin may include a first lateral wall and a second lateral wall. Further, the second lateral wall may include an outwardly angled deflection portion at a 45° angle relative to an axis of a spiral classifier disposed in the interior channel. Further, the basin may be configured for receiving a slurry of a particulate material. Further, the basin may be configured for guiding the slurry along the interior channel. Further, the basin may be configured for deflecting via the outwardly angled deflection portion, at least a portion of the particulate material from an elevated position to a lower position within the interior channel for reintroduction. Further, the cascading density separator may include the spiral classifier positioned within the basin and interposed between the first lateral wall and the second lateral wall. Further, the spiral classifier may be configured for rotating about the axis. Further, the spiral classifier may be configured for transporting a denser material from the particulate material upward within the interior channel. Further, the spiral classifier may be configured for displacing the particulate material toward the outwardly angled deflection portion during the rotating. Further, the cascading density separator may include a spray nozzle mounted to the basin. Further, the spray nozzle may be configured for spraying water into the interior channel. Further, the spray nozzle may be configured for washing a lighter material from the particulate material downward for discharge while enabling the denser material to be retained and lifted by the spiral classifier.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a top view of a cascading density separator 100, in accordance with some embodiments.

FIG. 2 illustrates a side view of the cascading density separator 100, in accordance with some embodiments.

FIG. 3 illustrates a second end view of the cascading density separator 100, in accordance with some embodiments.

FIG. 4 illustrates a rear perspective view of the cascading density separator 100, in accordance with some embodiments.

FIG. 5 illustrates a first end view of the cascading density separator 100, in accordance with some embodiments.

FIG. 6 illustrates the side view of the cascading density separator 100 mounted at an inclination, in accordance with some embodiments.

FIG. 7 illustrates a second end view of a cascading density separator 700, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

### Overview

Material classifiers have long been utilized in various industries for separating materials of different densities or compositions. The given devices are especially common in applications such as mineral processing, sand and gravel washing, and aggregate classification. Traditionally, classifiers utilize mechanical and fluid systems to wash, sort, and separate lighter materials, such as organic debris or fine particulate matter, from heavier materials, such as stones, sand, or ore.

One commonly used classifier design employs a tub-like structure in conjunction with a rotating auger or screw. The system generally consists of a stationary tub, which holds a mixture of water and the material to be classified. The rotating auger is positioned inside the tub and is responsible for conveying the heavier materials upward, while water spray nozzles, strategically placed within the system, wash away lighter materials, which are typically flushed out via an overflow raceway.

The primary components of traditional classifiers include a tub, an auger, water spray nozzles, and a raceway. For context a tub is a stationary vessel that holds the water and material mixture. The tub is generally circular or oval in shape and encloses the auger or screw mechanism. The auger is a rotating spiral screw, located within the tub, that lifts heavier materials to the top of the system, allowing them to be discharged. As the auger rotates, the auger carries the heavier materials upward, while the lighter materials are left behind to be washed out. Typically, the nozzles are located within the tub, whereby the given nozzles spray water onto the material, loosening lighter materials, such as fine sand, dirt, or organic matter. The water washes lighter materials downward and out of the system, typically over the edge of the tub. In the context of the prior art, the raceway is a channel or outlet which allows lighter materials, separated by the water, to be discharged from the system. The raceway ensures that only the desired heavier materials are retained, while unwanted materials are removed.

Despite the utility of the traditional designs, they come with several limitations. One significant problem is related to the shape of the tub. In most conventional classifiers, the tub's walls are either vertical or slightly inclined, which limits the number of opportunities for lighter materials to be washed away before the heavier materials are discharged from the top of the auger. Additionally, the given shape restricts the capacity of the system to reintroduce material that has not been adequately classified, resulting in less efficient separation and the potential loss of valuable heavier materials.

In conventional systems, the material being processed is conveyed to the top of the auger and discharged relatively quickly, which limits the time for water to wash away the lighter materials. Furthermore, the tub's shape may cause the material to accumulate unevenly, further reducing the classifier's efficiency. Traditional tubs with steep or vertical walls do not offer sufficient recirculation of materials within the classifier. As a result, some materials may be prematurely discarded, without adequate washing or classification. The shape of the traditional tub may result in uneven water flow, with some areas receiving too much water while others receive too little. The uneven distribution reduces the overall efficiency of the system in separating lighter materials from heavier ones. Due to the steep walls and design of the traditional classifier, the material moves too quickly through the system, leaving little time for the water to separate lighter materials thoroughly, leading to incomplete classification and loss of valuable resources. In prior art designs, the tub's steep walls may result in material accumulation at the base or along the sides of the tub, further impeding the classification process.

The present disclosure seeks to overcome the given limitations by introducing a material classifier with a uniquely shaped tub. The new design features a tub with a wall that extends outwardly from the auger at a 45° angle. The given specific angular configuration allows materials to be reintroduced into the classification system repeatedly before they are finally discharged at the top of the auger. As a result, the system offers a more thorough washing and reclassification process, improving the separation of lighter materials from heavier ones. Moreover, the use of water in the given new design enhances the classifier's effectiveness. Water sprayed into the system washes the material downward, taking advantage of gravity to further separate the lighter materials from the heavier ones. As the lighter materials are repeatedly washed downward, they are eventually flushed out through the raceway, leaving the heavier materials to be carried upward by the auger.

The outwardly angled wall allows material to cycle back through the classifier multiple times, ensuring that the lighter materials have more opportunities to be separated. Moreover, the 45° angle provides better water distribution throughout the tub, ensuring that all materials are evenly washed, thus improving the separation process. The design of the tub encourages a slower ascent of materials through the auger, giving water more time to separate lighter materials. Additionally, the new shape reduces the tendency for materials to accumulate at the bottom or sides of the tub, resulting in more consistent performance.

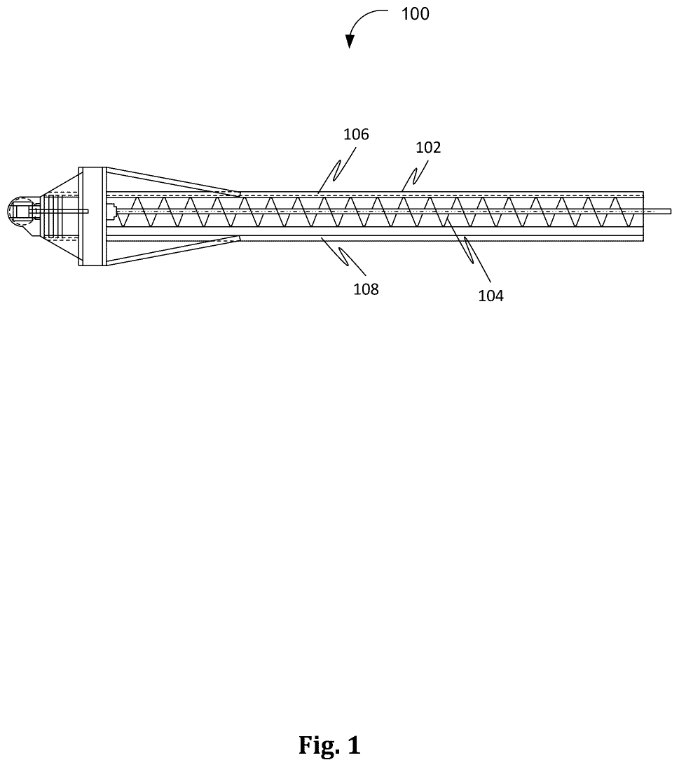

The present classifier, as shown in FIG. 1 through FIG. 7, is a cascading density separator comprising a spiral classifier and a basin. Further, the spiral classifier is an elongated helical apparatus. Moreover, in some embodiments, the spiral classifier is a helical screw.

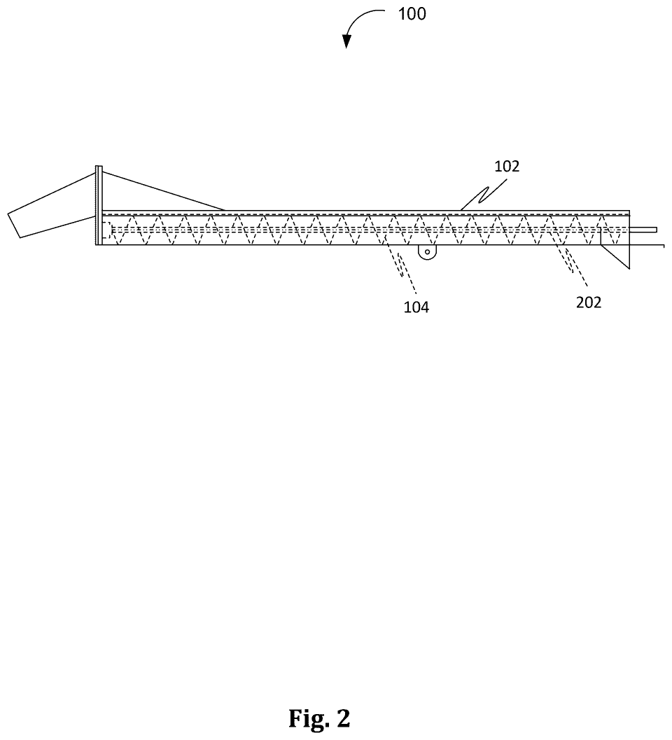

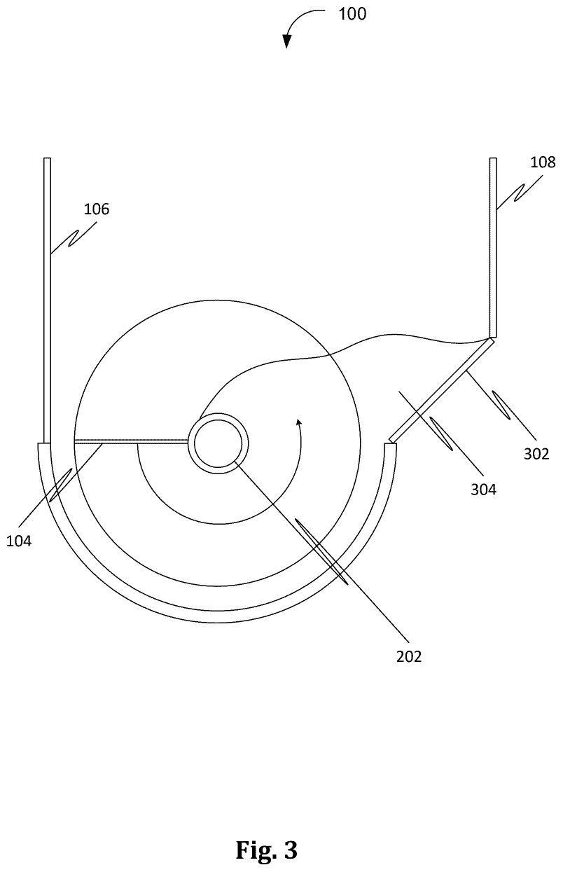

As shown in FIG. 1 and FIG. 2, in the preferred embodiment the spiral classifier comprises a plurality of helical blades, a shaft, and a length. Further, the shaft traverses the length of the spiral classifier, whereby the blades extend outwardly from the shaft. As understood, being that the spiral classifier is a screw, the blades extend in a manner as to form a helix. Further, as shown in FIG. 3, the spiral classifier further comprises a pitch and a major diameter. Further, in some embodiments, the pitch is 12 inches. Further, in some embodiments, the major diameter of the spiral classifier is 24 inches. Further, in some embodiments, the major diameter of the spiral classifier is 36 inches. Further, in some embodiments, the major diameter of the spiral classifier is 48 inches. Further, in some embodiments, the length of the spiral classifier is 30 feet. Further, in some embodiments, the length of the spiral classifier is 40 feet.

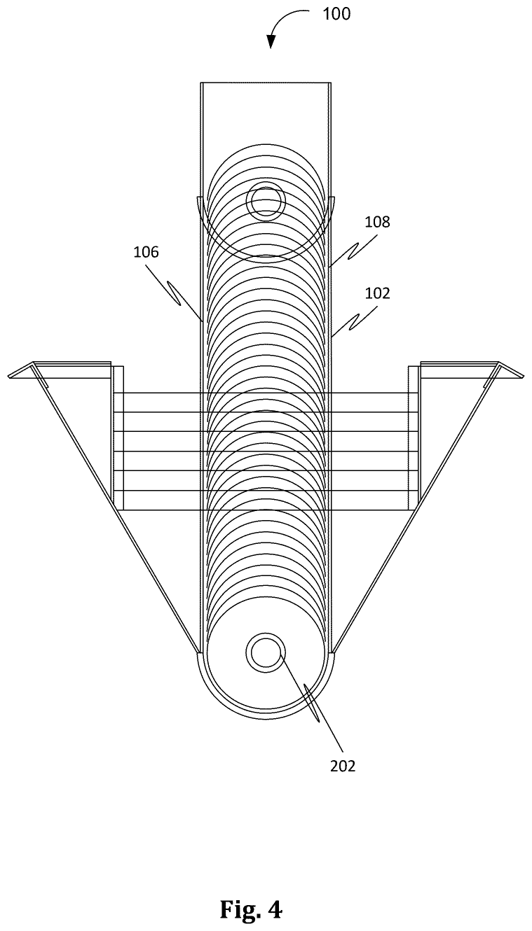

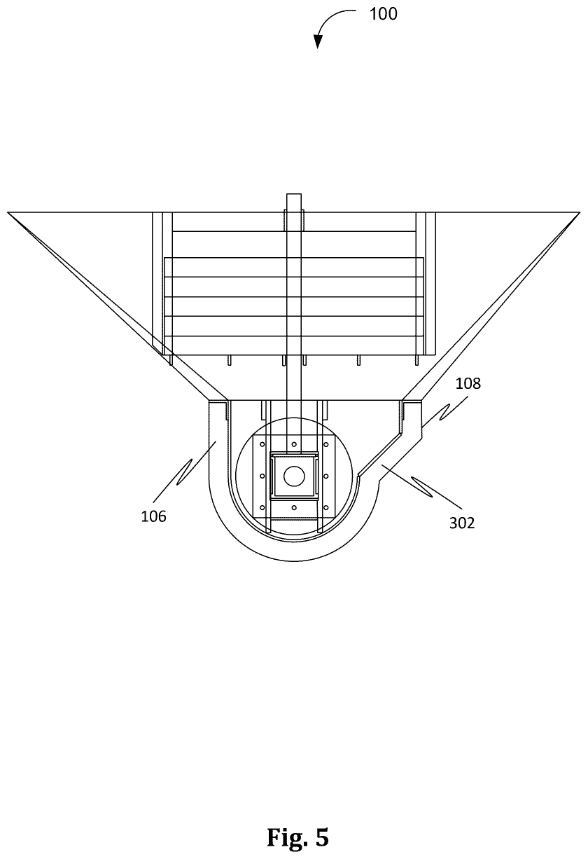

Likewise, as further shown in FIG. 1, FIG. 4, and FIG. 5, the basin is an elongated member comprising a length, an interior channel, a first end, a second end, a first lateral side, a second lateral side, and a bottom panel. Further, the first end and the second end each comprise a wall member whereby the wall member of the first end and the wall member of the second end are opposing wall members positioned on distal ends of the basin. Furthermore, the first lateral side and the second lateral side each comprise a wall traversing the length of the basin, wherein the first lateral side wall and the second lateral side wall are opposing walls. Further, the wall member of the first end, the wall member of the second end, the wall of the first lateral side, the wall of the second lateral side, and the bottom panel compose the interior channel.

In the preferred embodiment, as shown in FIG. 5, the bottom panel is semi-circular wherein the bottom panel is curved about a lower hemisphere of the spiral classifier. The bottom panel comprises a first side and a second side wherein the first lateral side wall member extends upwardly from the first side of the bottom panel, and the second lateral side wall member extends outwardly from the second side of the bottom panel. Further, the first lateral side wall member extends upwardly the length of major diameter. Further, the second lateral side wall member extends to a radial height of the spiral classifier, outwardly at a 45° angle at a length that is half of the major diameter, and upwardly to a height that is at least equal with the major diameter. Further, a radial height is half of the major diameter, wherein said radial height is coplanar with an imaginary centerline possessed by the shaft. Further, the junction of the bottom panel and the first lateral side wall member is a perpendicular angle.

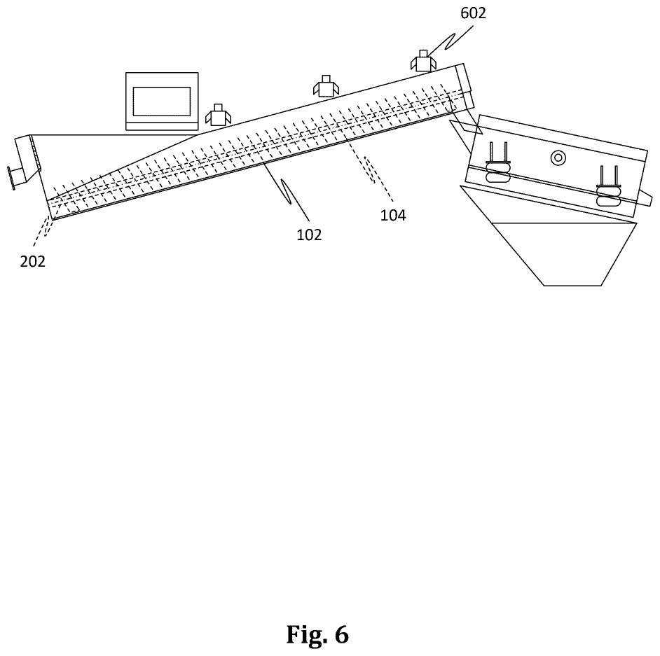

Further, as shown in FIG. 5 and FIG. 6, the spiral classifier is interposed between the first lateral side wall member and the second lateral side wall member. Furthermore, the spiral classifier rotates in direction from the first lateral side to the second lateral side, thus displacing material towards the 45° outwardly extended portion of the second lateral side wall member. Further, the first and end wall and the second end wall comprise a floating bearing wherein the shaft of the spiral classifier rotatably engages within said bearings. Further, the spiral classifier may rotate at a variable rate, as predetermined by a user.

As shown in FIG. 4 and FIG. 5, in some embodiments, the first end wall member comprises a weir slat system comprising a plurality of slats. Further, the plurality of weir slats control a water depth contained within the basin. Further, when filled with water, the plurality of slats may be added and removed to control the water depth as the water may only be contained to a depth that is equal in from the bottommost point of the bottom panel of the basin to the highest portion of the heights slat of the weir slat system. Furthermore, the classifier may comprise an inclination system wherein an inclination angle held by the basin and spiral classifier may be adjusted, as shown in FIG. 6.

In the preferred embodiment, the disclosed classifier separates materials of varying densities whereby material is disposed into the basin. As the spiral classifier rotates, causing material to move upwardly, water is continuously being sprayed into the system whereby the combination of the water and rotation of the spiral classifier causes the material to be dispositioned and continuously sorted. Because the second wall member extends outwardly at a 45° angle, the material is able to be discarded to a lower portion of the spiral classifier, thereby allowing recovery of finer particles, by reintroducing material into the system continuously.

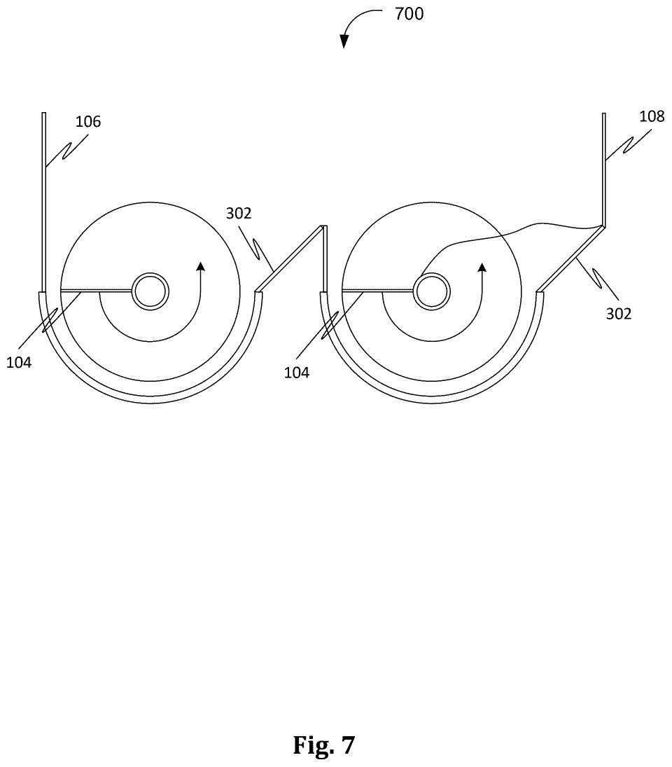

Additionally, in some embodiments, as shown in FIG. 7, the disclosed classifier may comprise an array of spiral classifiers. Further, the spiral classifiers may be configured in a horizontal array whereby the second lateral side wall member of a first spiral classifier is conjoined to the first lateral side wall member of a second spiral classifier. In such embodiments, as shown in FIG. 7, the first lateral side wall member of the second spiral classifier is at a radial height. Furthermore, in some additional embodiments, the disclosed classifier may comprise a vertical array of spiral classifiers. Additionally, in some embodiments, the disclosed classifier may further comprise a ferrous (magnetic) classifier whereby ferrous metals may be classified out from the materials.

In some embodiments, the cascading density separator may include a basin that defines an interior channel, a spiral classifier that rotates about an axis, and an outwardly angled deflection portion of a second lateral wall that forms a planar ramp disposed at about forty-five degrees relative to the axis to passively return displaced material from an elevated position to a lower position for reintroduction into the interior channel. Further, a first lateral wall may define a cylindrical inner surface concentric with the axis to confine upward transport, and a spray nozzle may be oriented to impinge a jet onto the planar ramp surface to wash a lighter fraction during the return. Further, the planar ramp may include an upper intercept edge positioned to intersect material displaced by the spiral classifier and a lower discharge edge vertically below the upper intercept edge to create a gravitational return path without a pump or an auger.

Further, in some embodiments, also disclosed is a continuous spiral classifier utilizing angle of attack, water rate and velocity, rotation direction and speed of flights with unique relief weirs for removal of debris from feed material that operates differently from all variations of classification screws for separation of mud from sand or lights from heavies. Sand screws and screw classifiers have been used for years that include open wide pitch flighting with discharge to left or right in a wide long weir for the removal of debris or retrievable light product fraction. In the sand screw the screw is typically turn left, pushing right. The pitch on a 36″ diameter screw is typically 18″ or ½ the screw diameter, (48″ screw would be 24″ pitch) and so on. The function is performed by charging the screw at approximately ⅓ of way up from back of screw with sand, dirt and other light particles. Water is introduced by spray nozzles and the screw is operated at varying inclination angles, typically 16 degrees and rotational rpm of 8-12. The water is introduced at various levels up the screw. The flighting is typically open with a 4-6″ band width. As the water contacts the material it washes out the lighter fraction and solubilizes the mud from the sand. In this way the finished product is clean sand that can then be used for various purposes.

In the classification screw the setup is essentially the same with varying amounts of water effecting the removal of lighter contaminants. In both cases the screws are of similar design with lighter material being discharged on the opposite side in which the screw is advancing material. This design has been used for sand washing, mineral recovery by density, metal recovery and other applications where a distinct difference in specific gravity exists between materials. Components are generally the same, Tub, frame, support structure, screw, open flights, water spray nozzles, ability to control angle and rpm, raceway for washout of lighter materials opposite direction of material wall movement.

Accordingly, in some embodiments, the disclosed apparatus i.e. Cascading Density Separator (CDS) provides a more effective means of recovering dense materials from lighter materials by altering the principal method of separation from discharging light contaminants opposite the lifting side of screw in a weir which runs from top to bottom of tub allowing the washout via gravity of the lights to a dewatering screen.

Further, in some embodiments, the screw is designed with variable pitch, rpm and lengths to achieve separation of various density mixes with screw having a much closer pitch and addition of water distribution boxes (slobber box) to control larger volumes of water to the process. Further, in some embodiments, the use of “slobber box” for major water intro into screw may be key to the process. Furthermore, the pump may also be controlled by a variable frequency controller that determines gallons per minute delivered to CDS.

Accordingly, the screw would turn (in right-hand configuration) to the left. This would push the feed material up the right-side wall, which rounded to receive the screw dimensions. The pitch would be 12″ on all screws regardless of the diameter and be of solid flighting. The primary difference is the relief at mid shaft on the right side against the lift wall. The side wall is cutout at mid-shaft and sloped on a 45° angle for various lengths depending on the screw diameter i.e. for 12″ screw the 45° relief would be 6″, on 18″ screw relief would be 8″ and so on or ½ the screw diameter. Upon installing this relief on right side wall the tub would then continue to vertical to height of opposite sidewall. As the material enters the screw it is pushed up the right sidewall, the water causes the lights to be washed out the right side via the relief along with small metal particles that subsequently fall back into the bottom of screw at various point up the slope. In this way, more finer particles are recovered.

Further, the disclosed apparatus may be configured for recovering denser materials from lighter materials that have been comingled by process. In the explanation of ASR (auto shredder residue) the ASR contains metal particles, AL, FE, Stainless Steel, Brass, Lead, Copper, ICW. This could be as much as 25% by weight and the majority (85%) is in the minus 2″ by 0 fraction.

First the waste stream is screened to 2″ by 0 and subsequently screened to 2″ by 1″ and 1″ by 0 sizes. When running the 1″ by 0 feed material the feed hopper discharges onto an incline conveyor that elevates the material to a wider conveyor belt where a ferric cross belt magnet removes much of the magnetic portion. The material continues to the CDS (cascading density separator) where it is introduced approximately ⅓ of way up. Further, the relief weir may be on the right side. As the material is propelled up the screw, the water flushing down the screw from the slobber boxes washes the lighter components and smaller metal pieces out onto the weir thereby moving it down the right side for discharge thru the rear weir. As the material goes onto the side weir the small metal pieces are reintroduced at a lower flight and returned to the bottom of the screw. This process continues up the entire length of the screw continually cleaning the metal until it is discharged at the top. Depending on rate required the CDS can be configured in various screw diameters and lengths.

In some embodiments, the disclosed apparatus works by controlling rate of feed to designed unit, while controlling amount and velocity of water added as media to affect cleaning and regulating angle of attack and speed and rotation of flights. The continuous cleaning or removal of contaminants from the metal pieces provides for maximum recovery of contained metal and removal of majority of waste components determined by size.

Further, the disclosed apparatus may be used when trying to separate comingled materials of various specific gravities. To separate dirt contaminants from sand, metal from metallurgical slags, metal from auto shredder residue, ores concentrate from mined ores and any other materials that have varying specific gravity components.

The current spiral classifiers have limited control in the separation of the different specific gravities in a given mixture the invention allows maximum control of all parameters to affect a clear separation of the constituent components while allowing the recovery of finer particles. This is achieved by the continuous reintroduction of the particles along the entire length of the screw. In the traditional technology the material is washed out of the flow of materials to the left of the screw where it is evacuated to the rear of the screw and discharged. In a 36″ screw that is 30′ in length with old tech there are 20 chances to separate material via density based on the pitch of the screw, (36″ is 18″ pitch or 20 flights).

In the CDS 36″ screw 12″ pitch 30′ long there are 30 chances to recover metal. Moreover, because the material is discharged to the right it never fully evacuates the screw until it reaches the bottom weir. This way there are 30 full chances to clean away lighter, less dense particles.

Further, in some embodiments, the disclosed apparatus may be effectively utilized in metal processing, scrap sorting, mining applications and coal separation or any other area where specific gravity differential exists between desirable materials and waste.

In some embodiments, an inherent technical improvement may address the problem of misplaced particle bypass that reduces selectivity in a conventional spiral, by using the outwardly angled deflection portion as a passive recirculation ramp that reintroduces partially separated material for additional classification passes. In some embodiments, the technology improved is gravity-based spiral classification, because the ramp enables an additional density discrimination stage without increasing footprint or adding a powered conveyor. In some embodiments, implementation may include a planar ramp, a slightly concave ramp that centers flow, or a faceted ramp that creates controlled stepwise potential drops; for example, a planar ramp may be formed as a welded plate integral to the second lateral wall, a cast monolithic wall segment with an integrally molded ramp, or a bolted liner panel that sets the ramp angle by a shim. In some embodiments, the intercept edge may be set radially inboard of an outer conveying edge of the helical flight so that a displaced stream impinges the ramp consistently across a range of rotational speeds.

In some embodiments, an inherent technical improvement may address the problem of uneven wash distribution that entrains lighter material with a heavier fraction by shaping the ramp to act as a laminarizing surface that spreads a thin water film across the reintroduction path. In some embodiments, the technology improved is slurry hydrodynamics within a spiral separator, because the film produces uniform shear on the returning solids. In some embodiments, implementation may include a ramp surface finish selected to an Ra that encourages film stability, a shallow convex curvature that suppresses cross-stream recirculation, or micro-grooves aligned with the downhill direction to meter film thickness; for example, a sand-cast ramp may be post-machined to a smoother finish, while a replaceable polymer liner may carry molded riblets that maintain a continuous film under variable flow.

In some embodiments, an inherent technical improvement may address the problem of reintroduction instability that creates dead zones near the spiral, by positioning a radial inner margin of the ramp closer to the axis than a radial outer margin to form a stable reentry corridor adjacent to the spiral classifier. In some embodiments, the technology improved is flow control inside the classifier, because the corridor constrains path line curvature and mitigates eddy formation. In some embodiments, implementation may include a leading lip that projects toward the spiral flight to damp cross-flow, a guide fillet that merges the ramp into the second lateral wall without a horizontal shelf, or a tapered ramp width that narrows toward the lower discharge edge to accelerate the return stream.

In some embodiments, an inherent technical improvement may address the problem of pooling and fouling at geometric discontinuities, by providing a smooth transition radius where the ramp joins the second lateral wall to eliminate an interruption in the return path. In some embodiments, the technology improved is solids handling reliability, because the rounded junction reduces stagnant volume. In some embodiments, implementation may include a fillet radius formed by a rolled plate, a cast radiused corner, or a bonded elastomer fillet; for example, a radiused insert may be fastened to an existing sharp corner to retrofit a smooth transition.

In some embodiments, an inherent technical improvement may address the problem of shear asymmetry across the channel that degrades classification by defining an annular interior cross-section with uniform radial clearance from the spiral to each lateral wall so that local velocity profiles remain balanced. In some embodiments, the technology improved is the internal flow field of the spiral channel. In some embodiments, implementation may include machining the first lateral wall to a true cylinder concentric with the axis, tramming the spiral shaft to reduce runout, and setting spacer pads along the ramp to hold a target clearance; for example, a set of gauged shims may be used during assembly to maintain a constant gap around the helical flight.

In some embodiments, an inherent technical improvement may address the problem of insufficient shear on a lighter fraction during return, by orienting the spray nozzle with an outlet axis tangential to the channel to create a sweeping sheet that impinges the ramp and urges the lighter fraction toward a discharge. In some embodiments, the technology improved is wash water delivery and separation efficiency. In some embodiments, implementation may include a nozzle with an adjustable orifice that sets flow rate, a swivel joint that sets azimuth, or a fan-to-cone geometry that changes droplet momentum; for example, a narrow fan may be used at low feed rate to minimize dilution, while a wider fan may be used when solids concentration increases.

In some embodiments, an inherent technical improvement may address the problem of process inflexibility under varying feed, by mounting the basin at an adjustable inclination relative to horizontal to tune a gravitational return time constant along the ramp. In some embodiments, the technology improved is machine adaptability in gravity separation. In some embodiments, implementation may include a pivot at one end of the basin and a jack screw or a wedge at the opposite end to change inclination, or a simple pin-indexed bracket with discrete angle positions; for example, a one-degree increase in basin tilt may lengthen return path residence only along the ramp while leaving spiral pitch unchanged.

In some embodiments, an inherent technical improvement may address the problem of uncontrolled dwell time for recirculated solids by driving the spiral classifier with a variable-speed motor so that rotational speed sets the rate at which displaced material reaches the intercept edge. In some embodiments, the technology improved is process control of spiral classification. In some embodiments, implementation may include a variable frequency drive that changes revolutions per minute, a closed-loop speed reference from a tachometer, or a manual selector with calibrated positions; for example, a lower rotational speed may increase dwell time on the ramp for feeds with a narrow density contrast.

In some embodiments, an inherent technical improvement may address the problem of misalignment that induces flight wobble and wall contact, by using a central shaft coaxial with the axis and a floor-mounted bearing that supports the shaft to hold the helical flight concentric with the channel. In some embodiments, the technology improved is mechanical stability of the rotating assembly. In some embodiments, implementation may include a self-aligning spherical bearing, a thrust bearing to carry axial load, or a tapered roller bearing for high load duty; for example, a thrust bearing may be located above the fluid line while a radial bearing at the floor maintains concentricity.

In some embodiments, an inherent technical improvement may address the problem of stagnant zones at the basin floor, by forming a floor contour that slopes toward the ramp so that returned material reenters the channel without a secondary eddy. In some embodiments, the technology improved is solids recirculation reliability. In some embodiments, implementation may include a shallow conical floor that biases toward the second lateral wall or a planar floor with a slight cross-fall toward the ramp; for example, a molded polymer floor panel may be fastened over a flat metal base to establish the designed slope.

In some embodiments, an inherent technical improvement may address the problem of intermittent interception at the reintroduction point, by shaping the upper intercept edge with a chamfer or a small convex bead so that the displaced stream consistently attaches to the ramp under variable flow. In some embodiments, the technology improved is capture efficiency at the handoff from the spiral to the ramp. In some embodiments, implementation may include a metal bead welded along the intercept edge, a molded rounded lip in a composite liner, or a replaceable wear cap that maintains the edge geometry over time.

In some embodiments, additional technical improvements may be introduced to further enhance specific technologies used in the separator. In some embodiments, a micro-textured ramp surface may be manufactured by additive manufacturing to embed riblets pattern or dimple arrays that modulate boundary layer behavior to reduce drag while sustaining a uniform film, thereby improving hydrodynamic separation technology beyond a smooth plate. In some embodiments, the technical problem is film breakup at higher flow, and implementation may include parallel micro-ridges with sub-millimeter spacing aligned with flow for laminar film guidance, dimple fields arranged in a hexagonal lattice to delay transition, or graded textures that coarsen toward the discharge edge to accelerate drainage; for example, a replaceable 3D-printed liner may include a chevron riblets field that prevents lateral meander of the film on the last third of the ramp.

In some embodiments, a closed-loop control subsystem may be added to improve mechatronic control of spiral classification by sensing return-stream clarity or particle size and adjusting spiral speed or basin inclination accordingly. In some embodiments, the technical problem is drift in cut-point under variable feed. In some embodiments, implementation may include a compact optical camera trained at the ramp to estimate turbidity, an ultrasonic transducer that measures near-surface solids concentration on the ramp, or a conductivity probe at the discharge; for example, a controller may increase rotational speed when a rise in fine heavy content on the ramp is detected to shorten return dwell.

In some embodiments, an actively modulated spray nozzle may be used to improve nozzle technology for slurry washing by pulsing the jet with a solenoid or a piezo actuator to create periodic shear bursts that detach loosely bound fines. In some embodiments, the technical problem is formation of a persistent boundary layer of fines during return. In some embodiments, implementation may include a variable-duty pulse train that cycles the jet at a low frequency to avoid atomization loss, a dual-mode nozzle that switches from a fan to a cone pattern during upset, or a jet that sweeps azimuth via a small servo; for example, a short pulse of higher momentum may be scheduled when the return stream thickness exceeds a threshold.

In some embodiments, a wear-sensing liner may be bonded to the ramp to improve maintenance technology by electrically monitoring liner thickness via embedded conductive traces or by acoustically monitoring via thin piezo elements, thereby addressing the technical problem of undetected ramp erosion that changes return geometry. In some embodiments, implementation may include a serpentine conductive path that opens when a local zone wears through, a capacitive grid that changes signal with thickness, or a piezo patch that detects impact rate of coarse particles; for example, a controller may alert an operator when a wear signal crosses a threshold so that the liner may be replaced before the angle of the return path drifts.

In some embodiments, a quick-adjust ramp angle mechanism may be added to improve configurability technology by enabling a small change in ramp angle without replacing parts, thereby addressing the technical problem of long downtime for mechanical reconfiguration. In some embodiments, implementation may include a hinged ramp panel with a locked eccentric cam to set angle, a wedge insert that slides under the ramp to change the effective angle, or a jack-screw that moves a distal support; for example, a two-position cam may switch the ramp between a high-recovery mode and a high-throughput mode during shift change.

In some embodiments, a patterned wettability coating may be applied to the ramp to improve surface engineering technology by guiding fluid via alternating hydrophilic and hydrophobic bands that steer the film while releasing adhered fines, thereby addressing the technical problem of fouling by clay-rich feeds. In some embodiments, implementation may include plasma-treated hydrophilic stripes that draw water across the ramp, fluoropolymer hydrophobic islands that encourage droplet roll-off, or a gradient pattern that transitions from hydrophilic at the intercept edge to more hydrophobic near the discharge edge; for example, a removable film may carry the pattern and may be replaced when contaminated.

In some embodiments, a low-amplitude vibratory exciter may be attached beneath the ramp to improve self-cleaning technology by imposing a high-frequency micro-acceleration that disrupts incipient caking without disturbing the main flow, thereby addressing the technical problem of progressive buildup under fine, sticky feeds. In some embodiments, implementation may include a piezoelectric patch bonded to the underside of the ramp, a small electromagnetic shaker tuned to a structural mode of the ramp, or a thin pneumatic pulsator that delivers short bursts; for example, a duty-cycled vibration may operate only during low load to conserve energy.

In some embodiments, the given inherent and additional features may be combined while preserving the primary passive recirculation mechanism created by the outwardly angled deflection portion so that each optional characterization remains dependent on and coordinated with the gravitational return path that distinguishes the separator. In some embodiments, specific dimensional values, materials, and control algorithms may be selected according to a feed type, a target cut-point, and a permitted energy budget, and may be changed without departing from the described improvements to gravity-based spiral classification, internal hydrodynamics, nozzle delivery, mechanical stability, configurability, surface engineering, wear monitoring, and mechatronic process control.

FIG. 1 illustrates a top view of a cascading density separator 100, in accordance with some embodiments.

Accordingly, the cascading density separator 100 may include a basin 102 defining an interior channel. Further, the basin 102 may include a first lateral wall 106 and a second lateral wall. Further, the second lateral wall 108 may include an outwardly angled deflection portion 302 at a 45° angle relative to an axis of a spiral classifier 104 disposed in the interior channel. Further, the basin 102 may be configured for receiving a slurry of a particulate material 304. Further, the basin 102 may include a first lateral wall 106 and a second lateral wall. Further, the basin 102 may be configured for guiding the slurry along the interior channel. Further, the basin 102 may include a first lateral wall 106 and a second lateral wall. Further, the basin 102 may be configured for deflecting via the outwardly angled deflection portion 302, at least a portion of the particulate material 304 from an elevated position to a lower position within the interior channel for reintroduction. Further, the cascading density separator 100 may include the spiral classifier 104 positioned within the basin 102 and interposed between the first lateral wall 106 and the second lateral wall. Further, the spiral classifier 104 may be configured for rotating about the axis. Further, the spiral classifier 104 may be configured for transporting a denser material from the particulate material 304 upward within the interior channel. Further, the spiral classifier 104 may be configured for displacing the particulate material 304 toward the outwardly angled deflection portion 302 during the rotating. Further, the cascading density separator 100 may include a spray nozzle mounted to the basin 102. Further, the spray nozzle may be configured for spraying water into the interior channel. Further, the spray nozzle may be configured for washing a lighter material from the particulate material 304 downward for discharge while enabling the denser material to be retained and lifted by the spiral classifier 104.

In some embodiments, the outwardly angled deflection portion 302 includes a planar ramp surface disposed at a 45° angle relative to the axis and projecting from the second lateral wall 108 toward the spiral classifier 104 to intercept the particulate material 304 displaced by the spiral classifier 104.

In some embodiments, the outwardly angled deflection portion 302 includes an upper intercept edge at an elevated position and a lower discharge edge within the interior channel. Further, the lower discharge edge may be positioned vertically below the upper intercept edge to provide a gravitational return of the particulate material 304.

In some embodiments, the outwardly angled deflection portion 302 includes a radial inner margin positioned closer to the axis than a radial outer margin for maintaining a stable reintroduction path adjacent to the spiral classifier 104.

In some embodiments, the outwardly angled deflection portion 302 presents a continuous, unobstructed surface between the upper intercept edge and the lower discharge edge to spread the water across the interior channel.

In some embodiments, the outwardly angled deflection portion 302 extends over a length to slow an ascent of the particulate material 304 along the interior channel and to increase a contact time with the water during recirculation.

In some embodiments, the outwardly angled deflection portion 302 joins the second lateral wall 108 with a smooth transition without a horizontal shelf for limiting an accumulation of the particulate material 304 within the basin 102.

In some embodiments, the outwardly angled deflection portion 302 provides a downward gradient along a return path from the upper intercept edge to the lower discharge edge to promote flushing of the lighter material for the discharge.

In some embodiments, the spray nozzle may be oriented to impinge a spray onto the planar ramp surface to maintain the washing during the gravitational return of the particulate material 304.

In some embodiments, the basin 102 may be mountable at an adjustable inclination relative to a horizontal to set a rate of the gravitational return along the outwardly angled deflection portion 302.

In some embodiments, the spiral classifier 104 may be drivable at a variable rotational speed. Further, the driving of the spiral classifier 104 at the variable rotational speed sets a dwell time for the particulate material 304 on the outwardly angled deflection portion 302.

In some embodiments, the first lateral wall 106 defines a continuous cylindrical inner surface concentric with the axis to confine the transporting of the denser material upward along the interior channel.

In some embodiments, the second lateral wall 108 includes a curved transition merging into the outwardly angled deflection portion 302 for guiding the particulate material 304 displaced by the spiral classifier 104 onto the outwardly angled deflection portion 302.

In some embodiments, the interior channel includes an annular cross-section bounded by the first lateral wall 106 and the second lateral wall 108 to establish a uniform radial clearance from the spiral classifier 104.

FIG. 2 illustrates a side view of the cascading density separator 100, in accordance with some embodiments.

In some embodiments, the spiral classifier 104 includes a helical flight of constant pitch about the axis for advancing the denser material upward.

FIG. 3 illustrates a second end view of the cascading density separator 100, in accordance with some embodiments.

In some embodiments, the spiral classifier 104 includes an outer conveying edge at a radius less than a radius of the outwardly angled deflection portion 302 for ensuring an intersection of the particulate material 304 displaced by the spiral classifier 104 with the outwardly angled deflection portion 302.

FIG. 4 illustrates a rear perspective view of the cascading density separator 100, in accordance with some embodiments.

In some embodiments, the spiral classifier 104 includes a central shaft 202 coaxial with the axis to maintain alignment of the helical flight under a load.

FIG. 5 illustrates a first end view of the cascading density separator 100, in accordance with some embodiments.

In some embodiments, the basin 102 includes a floor contour sloping toward the outwardly angled deflection portion 302. Further, the floor contour may be configured for directing the gravitational return of the particulate material 304 into the interior channel.

In some embodiments, the spray nozzle includes an outlet axis oriented tangentially to the interior channel to sweep the lighter material towards the discharge.

FIG. 6 illustrates the side view of the cascading density separator 100 mounted at an inclination, in accordance with some embodiments.

In some embodiments, the cascading density separator 100 may include a slobber box 602.

In some embodiments, the spray nozzle may be positioned above and laterally offset relative to the outwardly angled deflection portion 302. Further, the positioning of the spray nozzle above and laterally offset impinges the gravitational return of the particulate material 304 prior to a reentry into the spiral classifier 104.

FIG. 7 illustrates a second end view of a cascading density separator 700, in accordance with some embodiments.

Although the invention has been explained in relation to its preferred embodiment, it is to be understood that many other possible modifications and variations can be made without departing from the spirit and scope of the invention as hereinafter claimed.

What is claimed is:

1. A cascading density separator for facilitating density-based classification of particulate material, the cascading density separator comprising:
a basin defining an interior channel, wherein the basin comprises a first lateral wall and a second lateral wall, wherein the second lateral wall comprises an outwardly angled deflection portion at a 45° angle relative to an axis of a spiral classifier disposed in the interior channel, wherein the basin is configured for:
receiving a slurry of a particulate material;
guiding the slurry along the interior channel; and
deflecting via the outwardly angled deflection portion, at least a portion of the particulate material from an elevated position to a lower position within the interior channel for reintroduction;
the spiral classifier positioned within the basin and interposed between the first lateral wall and the second lateral wall, wherein the spiral classifier is configured for:
rotating about the axis;
transporting a denser material from the particulate material upward within the interior channel; and
displacing the particulate material toward the outwardly angled deflection portion during the rotating; and
a spray nozzle mounted to the basin, wherein the spray nozzle is configured for:
spraying water into the interior channel; and
washing a lighter material from the particulate material downward for discharge while enabling the denser material to be retained and lifted by the spiral classifier.

2. The cascading density separator of claim 1, wherein the outwardly angled deflection portion comprises a planar ramp surface disposed at a 45° angle relative to the axis and projecting from the second lateral wall toward the spiral classifier to intercept the particulate material displaced by the spiral classifier.

3. The cascading density separator of claim 2, wherein the outwardly angled deflection portion comprises an upper intercept edge at an elevated position and a lower discharge edge within the interior channel, wherein the lower discharge edge is positioned vertically below the upper intercept edge to provide a gravitational return of the particulate material.

4. The cascading density separator of claim 2, wherein the outwardly angled deflection portion comprises a radial inner margin positioned closer to the axis than a radial outer margin for maintaining a stable reintroduction path adjacent to the spiral classifier.

5. The cascading density separator of claim 3, wherein the outwardly angled deflection portion presents a continuous, unobstructed surface between the upper intercept edge and the lower discharge edge to spread the water across the interior channel.

6. The cascading density separator of claim 1, wherein the outwardly angled deflection portion extends over a length to slow an ascent of the particulate material along the interior channel and to increase a contact time with the water during recirculation.

7. The cascading density separator of claim 1, wherein the outwardly angled deflection portion joins the second lateral wall with a smooth transition without a horizontal shelf for limiting an accumulation of the particulate material within the basin.

8. The cascading density separator of claim 3, wherein the outwardly angled deflection portion provides a downward gradient along a return path from the upper intercept edge to the lower discharge edge to promote flushing of the lighter material for the discharge.

9. The cascading density separator of claim 2, wherein the spray nozzle is oriented to impinge a spray onto the planar ramp surface to maintain the washing during the gravitational return of the particulate material.

10. The cascading density separator of claim 9, wherein the basin is mountable at an adjustable inclination relative to a horizontal to set a rate of the gravitational return along the outwardly angled deflection portion.

11. The cascading density separator of claim 1, wherein the spiral classifier is drivable at a variable rotational speed, wherein the driving of the spiral classifier at the variable rotational speed sets a dwell time for the particulate material on the outwardly angled deflection portion.

12. The cascading density separator of claim 1, wherein the first lateral wall defines a continuous cylindrical inner surface concentric with the axis to confine the transporting of the denser material upward along the interior channel.

13. The cascading density separator of claim 1, wherein the second lateral wall comprises a curved transition merging into the outwardly angled deflection portion for guiding the particulate material displaced by the spiral classifier onto the outwardly angled deflection portion.

14. The cascading density separator of claim 1, wherein the interior channel comprises an annular cross-section bounded by the first lateral wall and the second lateral wall to establish a uniform radial clearance from the spiral classifier.

15. The cascading density separator of claim 1, wherein the spiral classifier comprises a helical flight of constant pitch about the axis for advancing the denser material upward.

16. The cascading density separator of claim 1, wherein the spiral classifier comprises an outer conveying edge at a radius less than a radius of the outwardly angled deflection portion for ensuring an intersection of the particulate material displaced by the spiral classifier with the outwardly angled deflection portion.

17. The cascading density separator of claim 15, wherein the spiral classifier comprises a central shaft coaxial with the axis to maintain alignment of the helical flight under a load.

18. The cascading density separator of claim 1, wherein the basin comprises a floor contour sloping toward the outwardly angled deflection portion, wherein the floor contour is configured for directing the gravitational return of the particulate material into the interior channel.

19. The cascading density separator of claim 1, wherein the spray nozzle comprises an outlet axis oriented tangentially to the interior channel to sweep the lighter material towards the discharge.

20. The cascading density separator of claim 1, wherein the spray nozzle is positioned above and laterally offset relative to the outwardly angled deflection portion, wherein the positioning of the spray nozzle above and laterally offset impinges the gravitational return of the particulate material prior to a reentry into the spiral classifier.
